(19) United States
(12) Patent Application Publication
(10) Pub. No.: US 2005/0155052 A1
(43) Pub. Date: Jul. 14, 2005

(54) Parental control for a networked multiroom system

(76) Inventors: Barbara Ostrowska, Lawrenceville, GA (US); Samuel H. Russ, Alpharetta, GA (US)

Correspondence Address: SCIENTIFIC-ATLANTA, INC.;INTELLECTUAL PROPERTY DEPARTMENT, 5030 SUGARLOAF PARKWAY, LAWRENCEVILLE, GA, 30044, US

(21) Appl. No.: 11/069,439

(22) Filed: Mar. 1, 2005

Related U.S. Application Data
(63) Continuation-in-part of application No. 10/403,485, filed on Mar. 31, 2003.
(60) Provisional application No. 60/416,155, filed on Oct. 4, 2002.

(51) Int. Cl. H04N 7/18; H04N 7/16; H04N 7/14

(52) U.S. Cl. 725/25; 725/28; 725/80; 725/30

(57) ABSTRACT

Interactive network guide with parental control in a networked multi-room system. The networked multi-room system is made up of one primary device and one or more remote devices where the primary device includes an indication of status of at least one of the remote devices. The user on the primary device can block presentations on any remote device on demand from the primary device. The block will expire when the presentations ends.

### CROSS-REFERENCE TO RELATED PATENT APPLICATIONS

The present application is a Continuation In Part (CIP) of U.S. patent application Ser. No. 10/403,485, which was filed on Mar. 31, 2003. The present application claims priority to U.S. provisional application having Ser. No. 60/416,155 filed on Oct. 4, 2002; also, the present invention is related to U.S. patent application Ser. No. 10/212,017, which was filed on Aug. 2, 2002, and U.S. patent application Ser. No. 10/235,201, which was filed on Sep. 5, 2002, and U.S. patent application Ser. Nos. 10/263,160, 10/263,449, and 10/263,270 which were filed on Oct. 2, 2002 the disclosure and teachings of which are hereby incorporated by reference.

### FIELD OF THE INVENTION

This invention relates in general to broadband communications systems, and more particularly, to the field of network multimedia systems having a multi-room interactive network guide.

### DESCRIPTION OF THE RELATED ART

Broadband communications systems, such as satellite and cable television systems, are now capable of providing many services in addition to analog broadcast video. In implementing enhanced programming, the set-top terminal (STT), otherwise known as the set-top box, has become an important computing device for accessing various video services. In addition to supporting traditional analog broadcast video functionality, many STTs now also provide other functionality, such as, for example, an interactive program guide (IPG), picture-in-picture (PIP) viewing, video-on-demand (VOD), subscription video-on-demand (SVOD) and functionality traditionally associated with a conventional computer, such as e-mail. Recently new functionality has been added to conventional STTs—namely the ability to record an incoming video stream in digitized form onto a mass storage device, such as a hard disk drive, and play back that recorded video as desired by the user. This functionality has become known as a “digital video recorder” (DVR) or personal video recorder (PVR) and is viewed as a superior alternative to conventional video tape recorders for capture and subsequent playback of programming content.

A STT is typically connected to a television set and located at the home of the cable or satellite system subscriber. Since the STT is located at a subscriber's premises, it typically may be used by two or more users (e.g., household members). Television has become so prevalent in the United States that the typical household may have two or more television sets, each television set requiring its own STT if the subscriber wishes to have access to enhanced functionality.

A networked multimedia system (NMS) is described in copending U.S. patent application Ser. No. 10/342,670, filed Jan. 15, 2003, the disclosure and teachings of which are hereby incorporated by reference. The NMS allows a plurality of remote devices in the premises to be locally networked (—i.e., home-networked). One of the remote devices typically acts as the server or primary device (i.e., the primary set-top terminal (STT)) in the NMS. The primary device receives and forwards upon request broadband multimedia presentations (e.g., analog or digital television channels (i.e., audio/video signals), IP signals, video-on-demand (VOD) signals, administrative signals, etc.) throughout the local network to the plurality of remote devices (i.e., client devices). Furthermore, the remote devices are each capable of requesting and seamlessly receiving from the primary device resident presentations, such as a stored or recorded presentation, the interactive program guide, or the network guide, for example. Additionally, the remote devices may independently receive presentations from and send upstream signals to the communications network. Accordingly, the remote devices may be simplified, less-costly versions of the primary device but are capable of utilizing, via the NMS, some or all of the advanced hardware and software features, such as memory, a mass storage device, software applications, or infrastructure for transmitting signals back to the headend, that are available in the primary device.

However, there exists a need for systems and methods that allow multiple users operating discrete STTs within a networked premises to have access to programming and content received by and/or stored in another STT. Therefore, there also exists a need for the ability to control and/or monitor the discrete STTs within the networked premises, such as a primary STT being able to view the content that is currently being or had been watched on a remote STT.

### BRIEF DESCRIPTION OF THE DRAWINGS

The invention can be better understood with reference to the following drawings. The components in the drawings are not necessarily drawn to scale, emphasis instead being placed upon clearly illustrating the principles of the invention. In the drawings, like reference numerals designate corresponding parts throughout the several views.

FIG. 1 is a simplified block diagram depicting a non-limiting example of a conventional broadband communications system with a networked multi-room system (NMS).

FIG. 2 illustrates a non-limiting example of one embodiment of an interactive program guide (IPG), which is suitable for use in the NMS of FIG. 1.

FIG. 3 illustrates the IPG of FIG. 2 further including functionality listings, such as a personal video recording (PVR) recorded list and the network guide (NG), among others.

FIG. 4 depicts a non-limiting example of a recorded programs list screen that may be presented to a remote device via the NMS of FIG. 1.

FIG. 5 illustrates a network guide screen in accordance with the present invention, which is suitable for use in the networked system of FIG. 1.

FIG. 6 illustrates a non-limiting example of a network guide screen for viewing past history of the remote devices.

FIG. 7 illustrates a non-limiting example of a network guide screen with options to monitor the remote devices.

FIG. 8 illustrates a non-limiting example of a display device screen displaying a display status change.

FIG. 9A illustrates a non-limiting example of a display device screen displaying a display status change.

FIG. 9B illustrates a non-limiting example of a display device screen displaying a display status change.

FIG. 10 illustrates a picture-in-picture screen within a larger screen.

FIG. 11 illustrates a non-limiting screen that displays a customize network guide screen.

FIG. 12 illustrates a non-limiting screen that displays all of the remote devices that are in the networked system of FIG. 1.

FIG. 13 illustrates a non-limiting example of a personal identification number (PIN) entry screen. FIG. 14 illustrates a non-limiting example of a PIN select screen.

FIG. 15 is a non-limiting example of a display status change screen that is presented to a user after the user selects the highlighted listing in FIG. 12.

FIG. 16 is a non-limiting example of a picture-in-picture (PIP) screen that is presented to a user after the user selects the highlighted listing in FIG. 12.

### DETAILED DESCRIPTION

The embodiments of the invention can be understood in the context of a broadband communications system and a local network system. Note, however, that the invention may be embodied in many different forms and should not be construed as limited to the embodiments set forth herein. For example, transmitted broadband signals may include at least one of video/audio, telephony, data, or Internet Protocol (IP) signals, to name but a few. Furthermore, remote devices included in the local network system receiving the transmitted broadband signals may include a set-top terminal (STT), a television, a computer, a personal digital assistant (PDA), or other display device. Moreover, in accordance with the present invention a multi-room interactive network guide can have various features, functions, and presentations when displayed. All examples given herein, therefore, are intended to be non-limiting and are provided in order to help clarify the description of the invention.

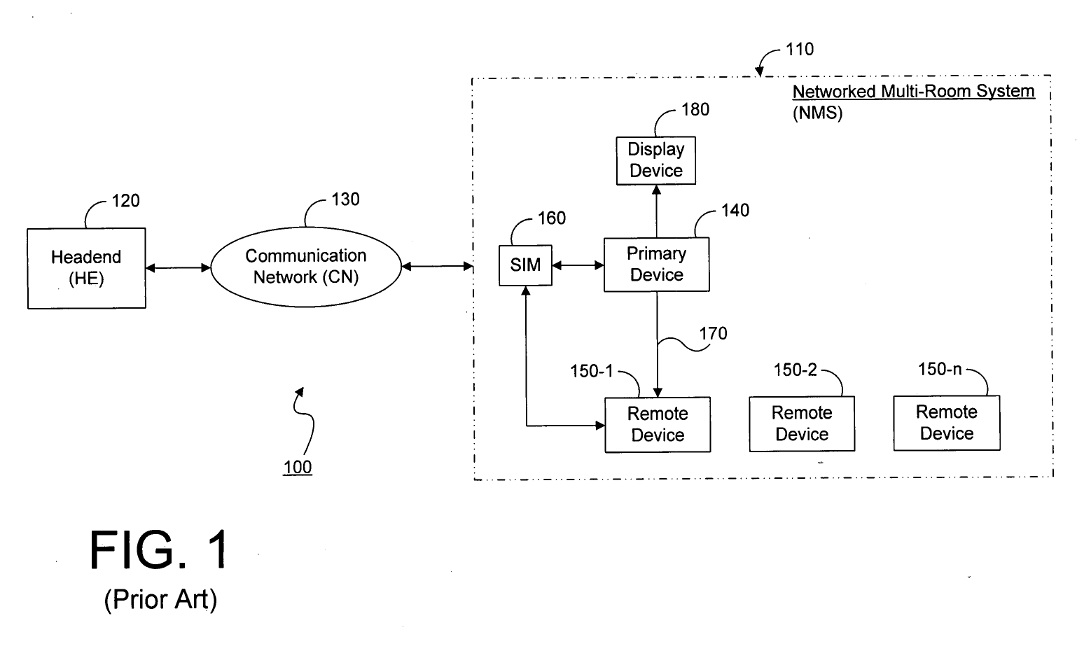

FIG. 1 is a simplified block diagram depicting a non-limiting example of a conventional broadband communications system 100. In this example, the communications system 100 includes a local networked multi-room system (NMS) 110 that is coupled to a headend (HE) 120 via a communications network (CN) 130. The CN 130 may be any network that is suitable for carrying, preferably downstream and upstream, broadband multimedia signals, such as audio/video signals, IP signals, telephony signals, or data signals to name but a few. The CN 130 may be, for example, a hybrid fiber/coax (HFC) network, a fiber-to-the-home (FTTH) network, a satellite network, or a fixed wireless network (e.g., MMDS), among others.

The HE 120 may include one or more server devices for providing broadband signals, such as video, audio, and/or data signals, to a primary device 140 via the CN 130. The HE 120 and the primary device 140 cooperate to provide a user with a variety of services. The services may include, for example, analog or digital broadcast television services and channels, video-on-demand (VOD) services, and/or pay-per-view (PPV) services, among others. Each broadcast television channel typically provides a sequence of television presentations corresponding to a television station (e.g., ABC, NBC, CBS, or FNN) and is typically identified by a channel number (e.g., channel 2, channel 3, channel 4) that is available to a user at all times. Additionally, PPV services are typically transmitted to the primary device 140 at all times, but can only be viewed on the primary device 140 as provisioned. On the other hand, the primary device 140 typically requests a VOD service and, subsequently, the HE 120 transmits the presentation downstream to the primary device 140.

The NMS can include a router, but as shown in FIG. 1, the NMS 110 includes a splitter/isolator module (SIM) 160 that receives downstream broadband signals from the HE 120 and subsequently provides the downstream signals to the primary device 140 or to both the primary device 140 and any one or all of the remote devices 150-1 to 150-n depending on the implementation. Upon command from at least one of the remote devices 150-1 to 150-n, the primary device 140 may also forward selected real-time downstream signals and/or stored content signals to the requesting remote device 150-1, for example, via the SIM 160. The remote device 150-1 communicates with the primary device 140 by sending reverse control/command signals via coaxial cable requesting stored presentations, real-time signals, or the network guide. Other wired mediums, such as telephone lines or data cables, may be used so long as the transport format accommodates the desired transmission medium. The remote devices 150-1 to 150-n have access to all of the primary device 140's hardware and software functionality, along with receiving downstream signals directly from the headend via the SIM 160. Therefore, the remote devices 150-1 to 150-n may have limited resources, such as not including a storage device in order to record and store a presentation, thereby decreasing the overall costs to the service provider and the subscriber while offering advanced services to all of the remote devices 150-1 to 150-n that are networked to the primary device 140.

Furthermore, the primary device 140 may also directly provide signals, such as analog and digital channels, stored presentations, or the network guide to name but a few, to a coupled display device 180, which may be, for example, a television, computer, or PDA (personal digital assistant), among others. The primary device 140 may transmit signals to and receive control signals from the display device 180 via wireless devices (e.g., RF or IR devices) or a wired medium (e.g., coaxial cable, power lines, or telephone lines). It will also be appreciated that the primary device 140 may be incorporated in the display device 180.

The primary device 140, in accordance with one embodiment of the present invention, includes a processor, a tuner system, a storage device, a modulator, and a remote device communications receiver. Each of the remote devices, such as the remote device 150-1, may be identical to the primary device 140 and just share the storage device contents of the primary device 140. Alternatively, the remote device 150-1 may be a simplified or conventional version of the primary device 140. A processor and a tuner system, which may be a simplified processor and only one tuner, may be included to extract channels from the received downstream broadband signals. Additionally, decryptors and decoders may be included to decode encoded signals for proper processing and display. Preferably, the remote device 150-1 includes a user input receiver, such as an IR receiver or an RF receiver, that receives signals from a remote control, such as an IR remote control or an RF remote control. The remote control is not required and any user input device could be incorporated in the remote device 150-1.

In the event that the remote device 150-1, upon user input, requests a presentation, a reverse command signal is transmitted from the remote device 150-1 to the primary device 140 via the SIM 160. The remote device command receiver receives and demodulates the command signal according to its transmission method, such as frequency-shift keying (FSK) or on-off keying (OOK) transmission. The processor subsequently receives the demodulated command signals indicative of the requested action (e.g., requesting a presentation) and in accordance therewith instructs the tuner to tune to, for example, a channel carrying a real-time downstream signal, or the processor may retrieve a stored presentation from the storage device. The presentation's content signals are then provided to the modulator, which modulates the selected presentation prior to forwarding to the SIM 160. A preferred embodiment of the present invention uses a quadrature amplitude modulation (QAM) modulator, which may be used for effectively transmitting signals over coaxial cable in a cable television environment.

The presentations stored in the storage device of the primary device 140 include program identifiers (PIDs), which may be indexed and stored as a table in the primary device's memory. The remote devices 150-1 to 150-n may watch a single stored presentation by remapping the PID value of the stored program to a different PID value prior to modulation. In this manner, the single stored program basically remains in the storage device, while the transmitted presentation is a copy of the stored presentation having a remapped PID value.

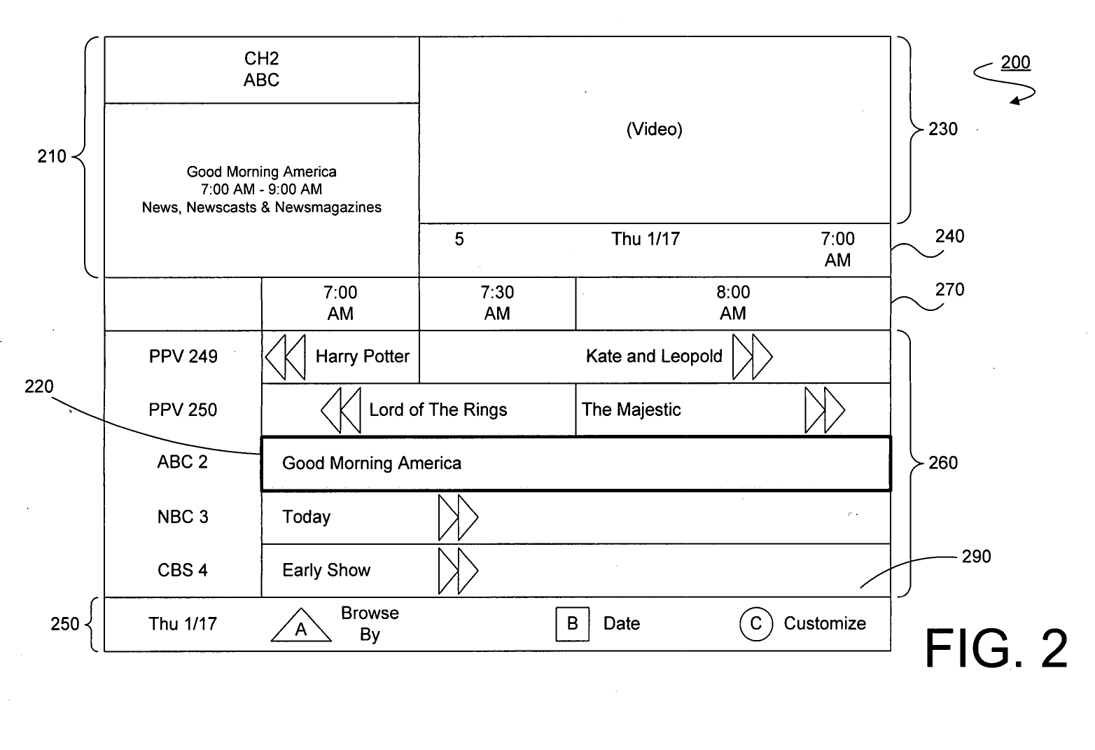

FIG. 2 illustrates a non-limiting example of an interactive program guide (IPG) screen 200 that is suitable for use in the NMS 110 of FIG. 1. The IPG screen 200 may be presented in response to user input that may be provided via the activation of a guide key on the remote control. In the top right of the IPG screen 200, video corresponding to the channel to which the primary device 140 is currently tuned may be displayed in the video screen 230. Immediately below the video area 230 is an information banner 240 for displaying the channel number corresponding to the channel to which the primary device 140 is currently tuned, the current day and date, and the current time.

In one embodiment, arrow buttons on the remote control can be used to scroll through a main presentation listing 260 and to highlight a desired presentation 220. The top left portion of the IPG screen 200 is a detailed focus area 210 that includes detailed information for a currently highlighted presentation 220. The detailed focus area 210 may include channel number, channel description, presentation name, duration of the presentation, and/or any episode information or rating. As a user scrolls in time across a calendar day boundary 270, the day and date indications displayed in various areas are updated. The bottom area 250 of the IPG screen 200 also indicates the current day for which presentation listing data is being displayed as well as information about the current functions of the optional “A,” “B,” and “C” keys that may be on the remote controls and are used in conjunction with the IPG. Further information regarding an interactive program guide can be found in copending U.S. patent application Ser. No. 10/212,017 filed on Aug. 2, 2002, the disclosure and teachings of which are hereby incorporated by reference.

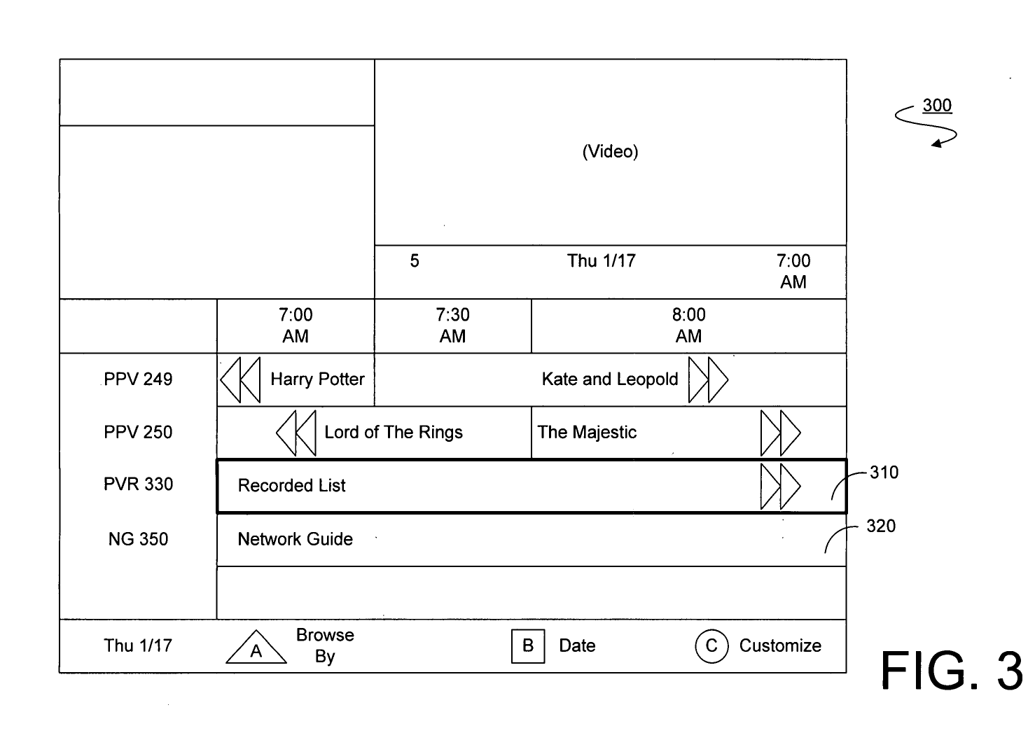

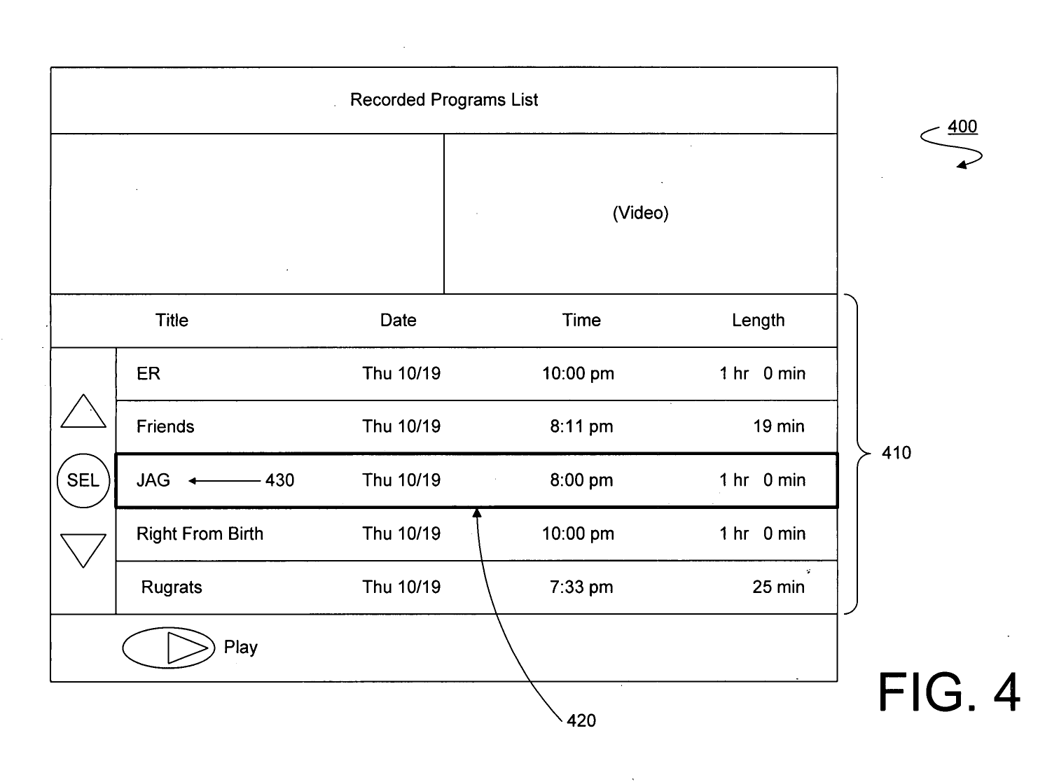

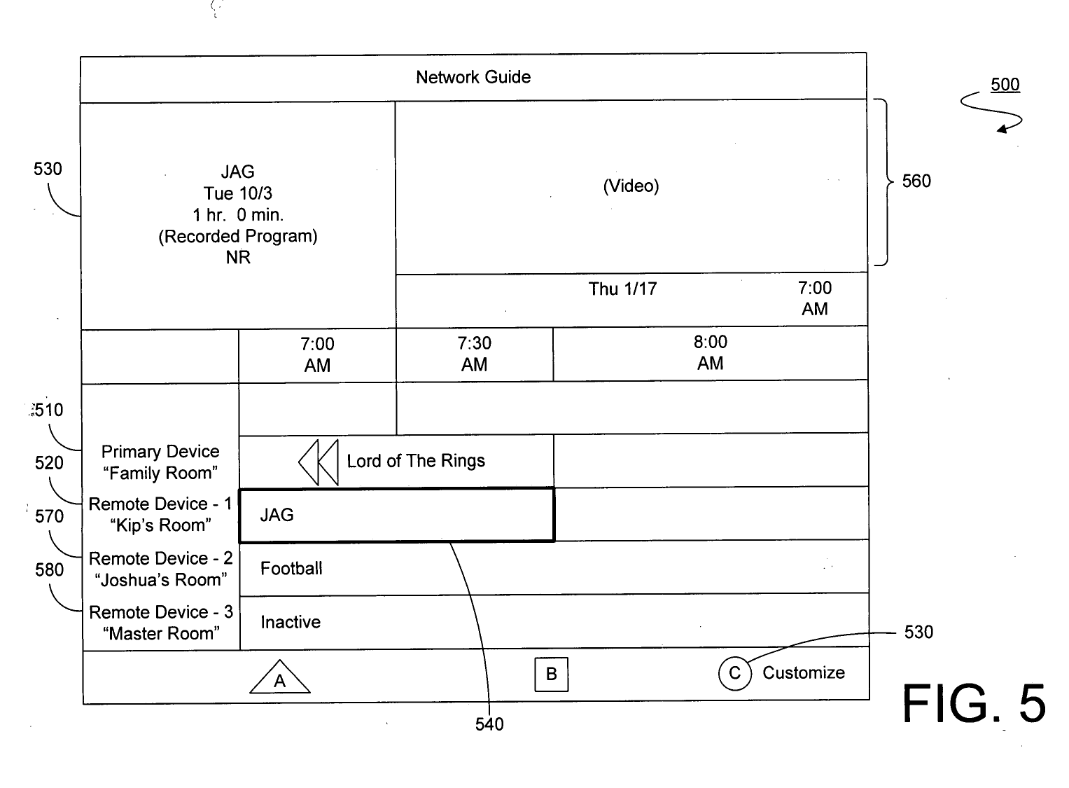

FIG. 3 illustrates the IPG 200 of FIG. 2 further including functionality listings, such as a personal video recording (PVR) listing 310 and a network guide listing (NG) 320. Highlighting and selecting the PVR listing 310 accesses a recorded programs list screen 400 as shown in FIG. 4. Additionally, highlighting and selecting the NG listing 320 accesses a network guide 500 as shown in FIG. 5 in accordance with the present invention. Alternatively, the user can select the channel number using number keypads on the remote control, such as entering numbers 330 or 350, respectively.

FIG. 4 depicts a non-limiting example of the interactive recorded programs list screen 400 showing a portion of a recorded programs list 410 that may be presented to the remote devices 150-1 to 150-n via the NMS 110 of FIG. 1. The recorded programs list screen 400 displays a list that includes all the recorded programs 410 showing, for example, the title, the recording date and time, and the length of the program. A presentation in the highlighted program line 420 can typically be selected for viewing by pressing a select button or a play button on a remote control. When a remote device 150-1, for example, requests a list of the recorded programs, the processor accesses the recorded programs 410, which is stored in memory, and subsequently forwards the content signals indicative of the recorded programs 410 to the modulator for modulation and transmission to the requesting remote device 150-1.

For example, a presentation 430 entitled JAG was recorded on Tuesday, October 3 and is one hour in length. After the user selects the presentation 430, the remote device 150-1 sends a reverse command signal that is indicative of the selected presentation (i.e., JAG) to the remote command receiver via the SIM 160. The processor extracts JAG from the storage device using an identifier. The presentation 430 is subsequently modulated and transmitted to the SIM 160 for delivery to the remote device 150-1. The requesting remote device 150-1 tunes to the modulator frequency and waits for the response (i.e., the presentation 430 entitled JAG).

FIG. 5 illustrates the network guide 500 in accordance with the present invention that is suitable for use in the networked system 110 of FIG. 1. The network guide 500 provides an onscreen display of a program grid menu that includes a status history for each remote device 150-1 to 150-n including past and present presentations. The primary device 140 can easily store in memory, such as the hard drive, the past viewings of each remote device 150-1 to 150-n, thereby allowing a user to view any past history for a predetermined amount of time. It will be appreciated that the network guide 500 typically defaults to real-time viewing information.

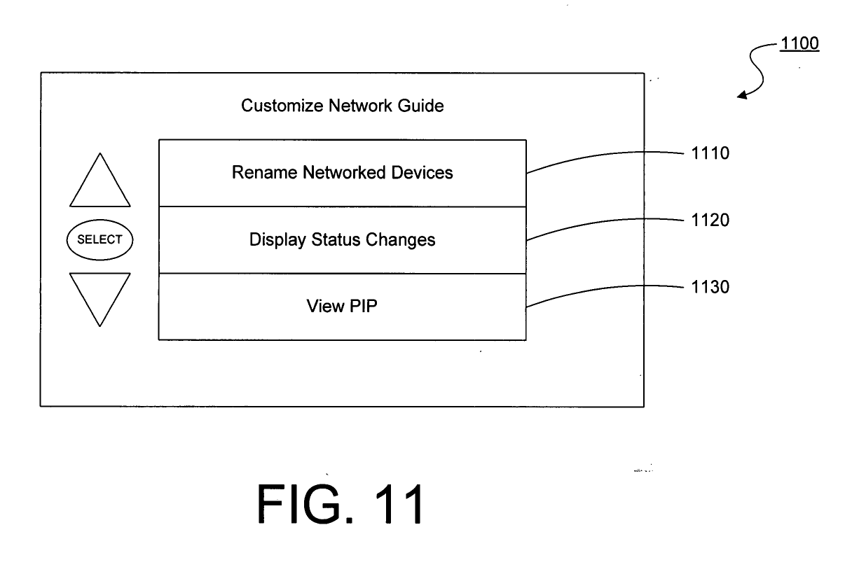

The network guide 500, which is stored on the primary device 140, provides customization options for the primary device 140 and all of the remote devices 150-1 to 150-n. Upon customization of either the primary device 140 or one of the remote devices 150-1 to 150-n, the updated network guide 500 is saved with the new information. The primary device 140 then broadcasts, either upon request or in a carousel manner, the customized network guide 500 to the remote devices 150-1 to 150-n. Alternatively, the network guide 500 can be customized from any one or each of the remote devices 150-1 to 150-n. In this implementation, the user accesses the network guide 500 and uses the customization screen 1100 (FIG. 11) to customize each remote device individually or all of the primary device 140 and the remote devices 150-1 to 150-n in the NMS 110. Once customized, the remote device 150- 1, for example, transmits the new information via the SIM 160 to the primary device 140 in order to update the network guide 500, which is stored in the primary device 140. The primary device 140 then broadcasts, either upon request or in a broadcast carousel, the customized network guide 500 including, for example, renamed remote device 150-1, to the plurality of remote devices 150-2 to 150-n.

Still referring to FIG. 5, the primary device 510, which has been named “Family Room,” is currently showing the presentation Lord of the Rings. Similarly, the network guide 500 displays the activity regarding the networked remote devices 150-1 to 150-n. Remote Device-1, having reference number 520, has been named “Kip's Room.” The network Remote Device-2 “Josh's Room” 570 is currently watching Football. The network Remote Device-3 “Master Room” 580 is currently inactive (e.g., turned off or watching a movie via a connected VCR or DVD player). Remote Device-1 “Kip's Room” 520 is presently showing an earlier recorded presentation 540 of JAG. Additionally, a detailed focus area 550 displays the information regarding the highlighted presentation 540. For example, the presentation 540 of JAG is a recorded program that was recorded on Tuesday, October 3, and the duration is an hour. There is also no rating (NR) given for this presentation. The top right of the network guide 500 displays the real-time channel of the primary device 140 in the video screen 560. Unobtrusive parental monitoring can be allowed via the video screen 560 of the real-time channel or recorded presentation being watched on any of the remote devices 150-1 to 150-n to be shown in the video screen 560 when the particular presentation was highlighted in the network guide 500. For example, the presentation 540 of JAG is highlighted and the video would appear in the video screen 560 of the network guide 500.

The primary device 140 inherently knows what presentation each remote device 150-1 to 150-n is currently receiving when the presentations originate from the primary device 140. By way of example, the processor processes command signals from a remote device 150-1 requesting a stored presentation. The processor accesses the presentation from storage and routes the content signals indicative of the presentation to the modulator. The modulated presentation is subsequently provided to the remote device 150-1 via the SIM 160. The processor updates the network guide 500 with the presentation name and detailed information regarding the presentation along with the requesting remote device name and/or address. Similarly, the primary device 140 is aware of a tuned presentation (e.g., a television channel or a VOD presentation) that is provided to a remote device 150-1 via the tuner system in the primary device 140.

There are times, however, when remote devices receive presentations without the assistance of the primary device 140. Some of the following examples may require only one tuner. However, some may require multiple tuners. For example, the remote device 150-2 may itself tune to a different television channel using an internal tuner system or the remote device may be turned off. Therefore, in one embodiment, the primary device 140 may request an indication of status from the remote device 150-2 in order to update the network guide 500. In which case, the processor in the primary device 140 sends a request signal to the remote device 150-2. In response, the remote device 150-2, via its processor, sends reverse command signals to the primary device 140's processor indicating its activity (e.g., presentation name, tuned channel, inactive, etc.). In another embodiment, each of the remote devices 150-1 to 150-n may send command signals updating their status on a regular basis. For example, the remote devices 150-1 to 150-n transmit reverse command signals indicating their activity every five seconds. In another embodiment, the remote devices 150-1 to 150-n may send command signals only when there is a change in activity (e.g., a channel change, power down, etc.), thereby potentially saving bandwidth. In another embodiment, the HE 120 can be used to relay messages between the primary device 140 and the remote devices 150-1 to 150-n. In yet another embodiment, if the tuners of the remote device 150-1 to 150-n can not be tuned to a multi-room QAM channel, a FSK demod can be added to each remote device 150-1 to 150-n so that each device knows the status of the others. It will be appreciated that in a further embodiment, the network guide 500 can be updated by using a combination of the embodiments.

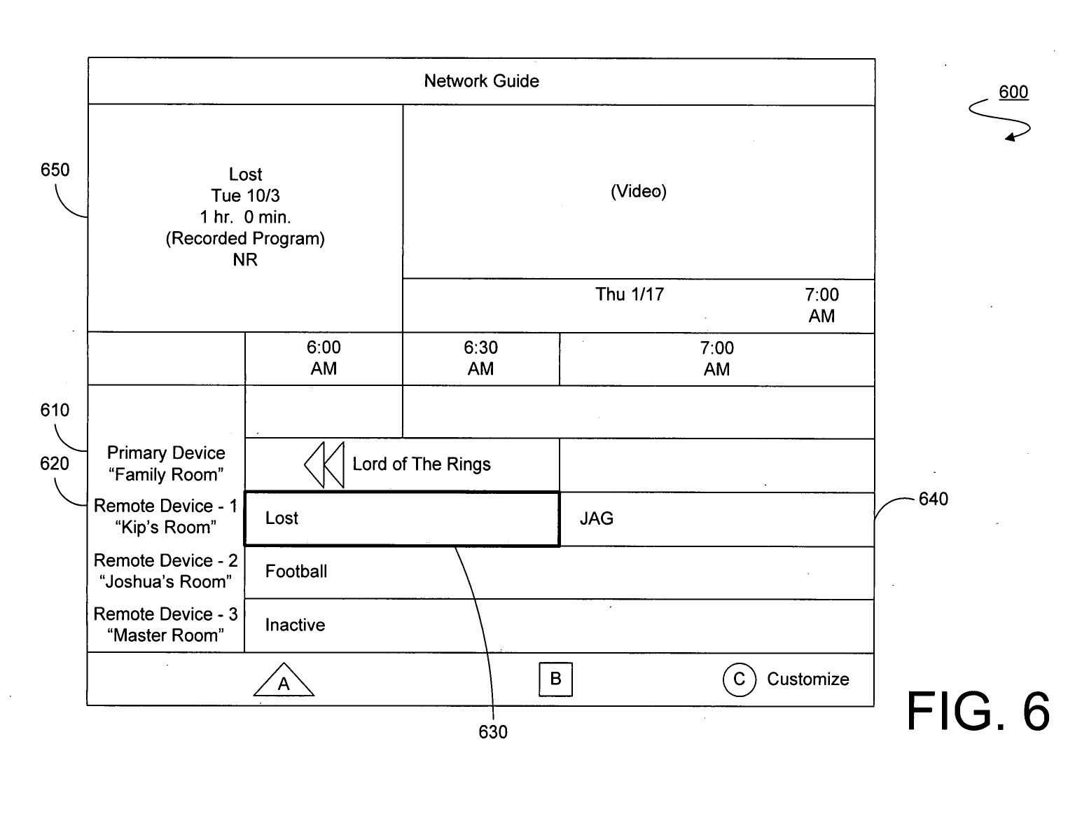

FIG. 6 illustrates another network guide screen 600 in accordance with an alternative embodiment of the present invention that is suitable for use in the networked system of FIG. 1. In this embodiment, the network guide screen 600 displays the past and current activity for each of the networked remote devices 150-1 to 150-n. The network guide screen 600 may default to real-time viewing information, but a user can easily view the past viewing information. To view the past history of the remote devices 150-1 to 150-n, the user would highlight the current real-time viewing information of a specific remote device, such as remote device 150-1, and then use the left arrow button on a remote control to scroll back through the saved history. For example, in FIG. 6, the current time is 7 AM, and Remote Device-1 “Kip's Room” 620 is currently viewing the presentation 640 of JAG which began at 7 AM. However, by using the remote control, the user may scroll back to 6 AM and see that the remote device 620 played a presentation 630 of Lost beginning at 6 AM.

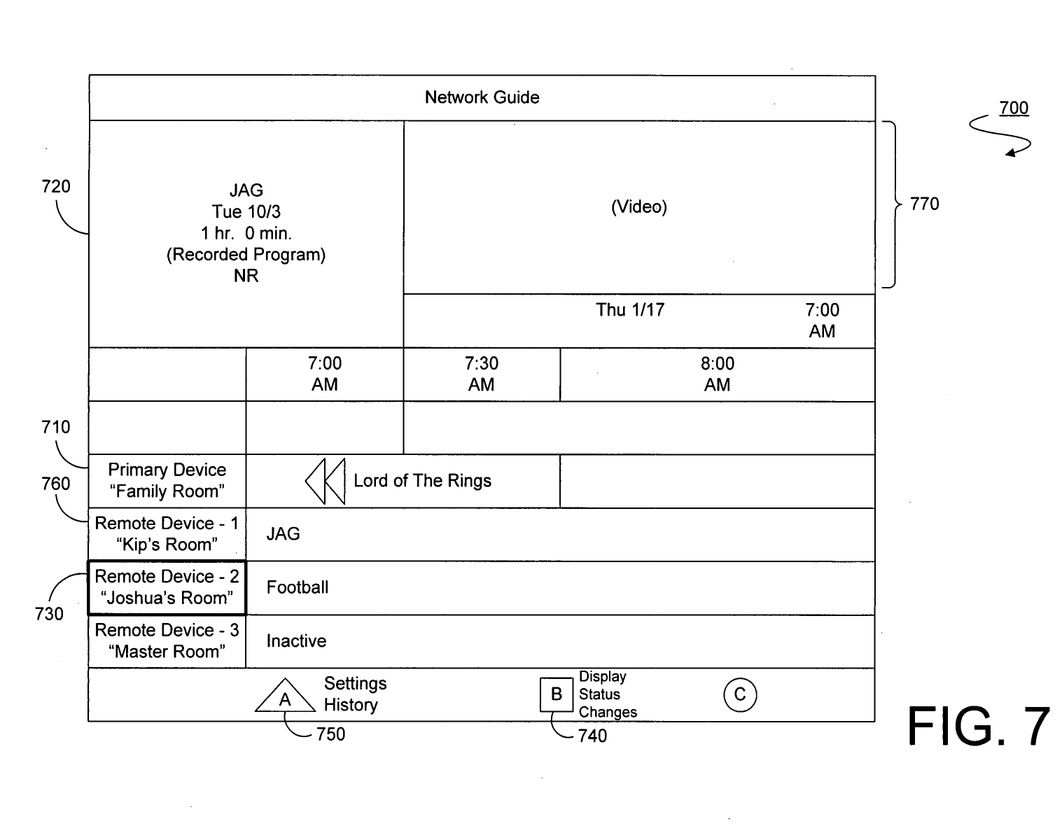

FIG. 7 illustrates a network guide screen 700 in accordance with another embodiment the present invention that is suitable for use in the networked system of FIG. 1. In this embodiment, the user is able use the arrow buttons on a remote control to select a particular remote device, such as Remote Device-2 “Joshua's Room” 730. Once a device is highlighted, there are several options to the user. The “A” icon 750 and “B” icon 740 on the network guide screen 700 may correspond to “A” and “B” buttons on a remote control.

The “A” icon 750 is labeled Settings History and would allow a user to see detailed information about the use of a specified remote device. For example, the user would highlight Remote Device-2 “Joshua's Room” 730 and would be able to view volume adjustments, change of channel, when the device was turned on and off, or other features accessed with the remote control on the remote device.

The “B” icon 740 is labeled Display Status Changes. This feature allows a user to monitor the activity of any of the remote devices 150-1 to 150-n on the display device 180 attached to the primary device 140. Once activated, changes in status will appear on the display device 180 every time there is a change. For example, as shown in FIG. 7, Remote Device-2 “Joshua's Room” 730 is currently watching football. If the remote device 730 were turned off, a status change would be displayed as an icon on the display device 180 notifying the user that the remote device 730 in Joshua's Room has turned off.

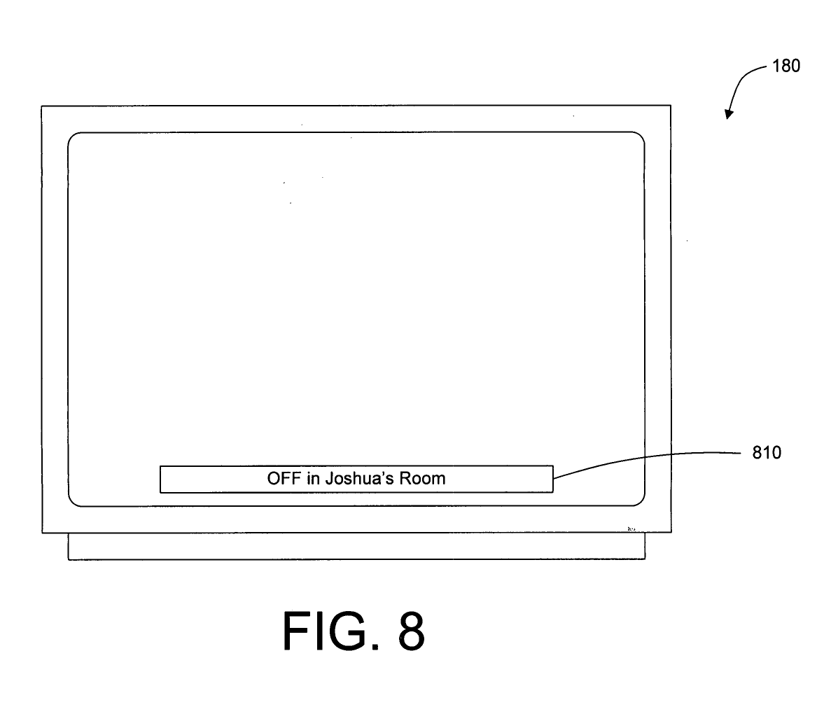

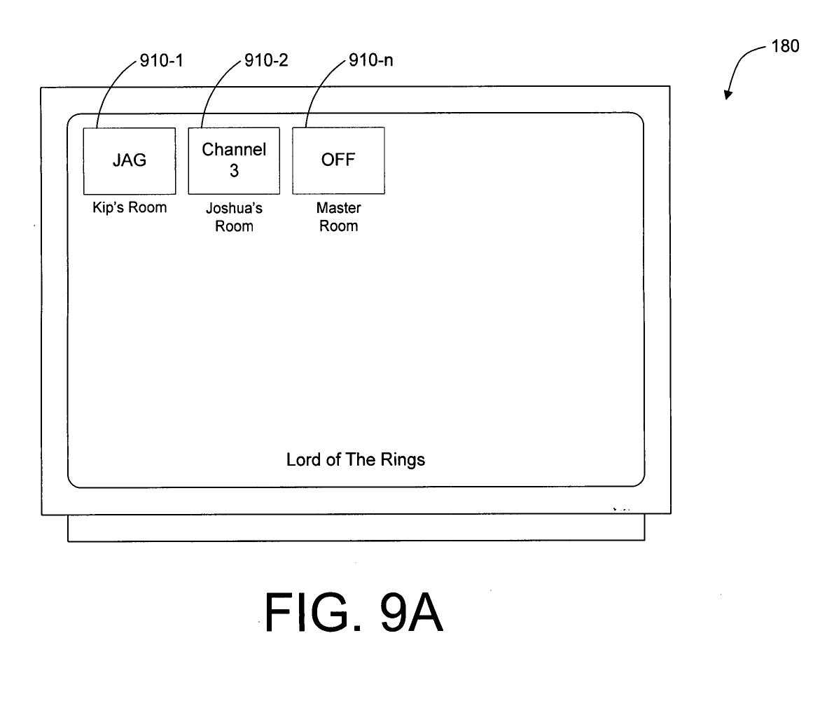

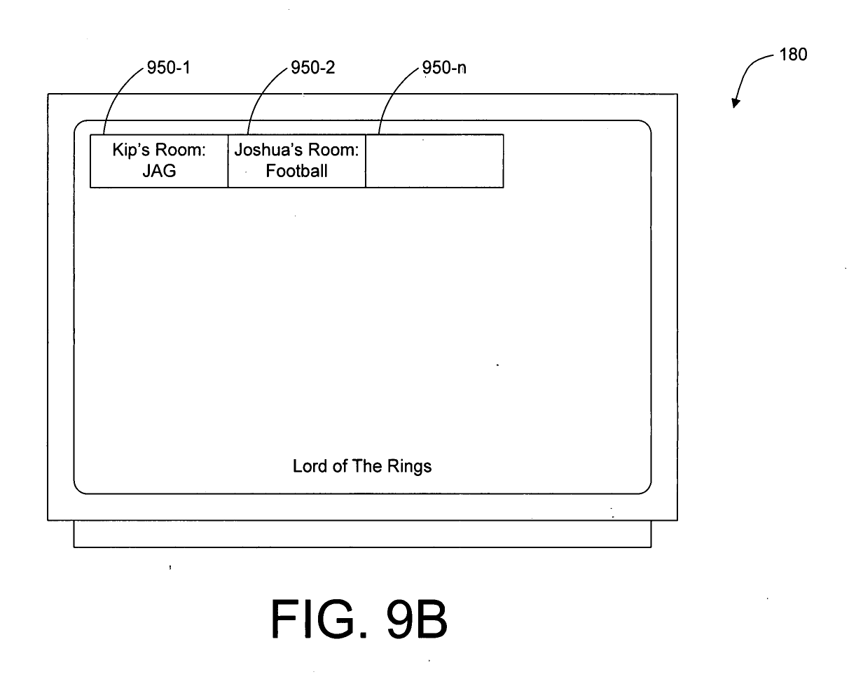

FIG. 8 shows the display device 180 with a display of status change 810 at the bottom of the display device 180 stating “Off in Joshua's Room.” The display of status change 810 could be any form of text and/or icons. The display of status change 810 could appear anywhere on the screen of the display device 180, not just the bottom. Preferably, this option is turned on for each individual remote device. The network guide could then reappear on the display device 180 after each change in status. In another embodiment, as shown in FIG. 9A, the display device 180 connected to the primary device 140 displays icons 910-1 to 910-n corresponding with each of the remote devices 150-1 to 150-n, respectfully. Each of the icons 910-1 to 910-n gives either a text or video display relating to the current status of each remote device 150-1 to 150-n. Preferably, only the active remote devices 150-1 to 150-n would be displayed.

FIG. 9B shows an alternate embodiment with a display of status 950-1 to 950-n at the top of the display device 180. To activate the display of status 950-1 to 950-n, the user would press a specified button on the remote control. The display status 950-1 to 950-n textually notifies the user what each remote device 150-1 to 150-n is currently viewing. The display status 950-1 to 950-n is selectable so that a user can arrow through the display status 950-1 to 950-n. If the user wishes to view the current presentation on one of the remote devices 150-1 to 150-n, the user utilizes the PIP option buttons on a remote control to create a PIP view of the presentation as shown in FIG. 11.

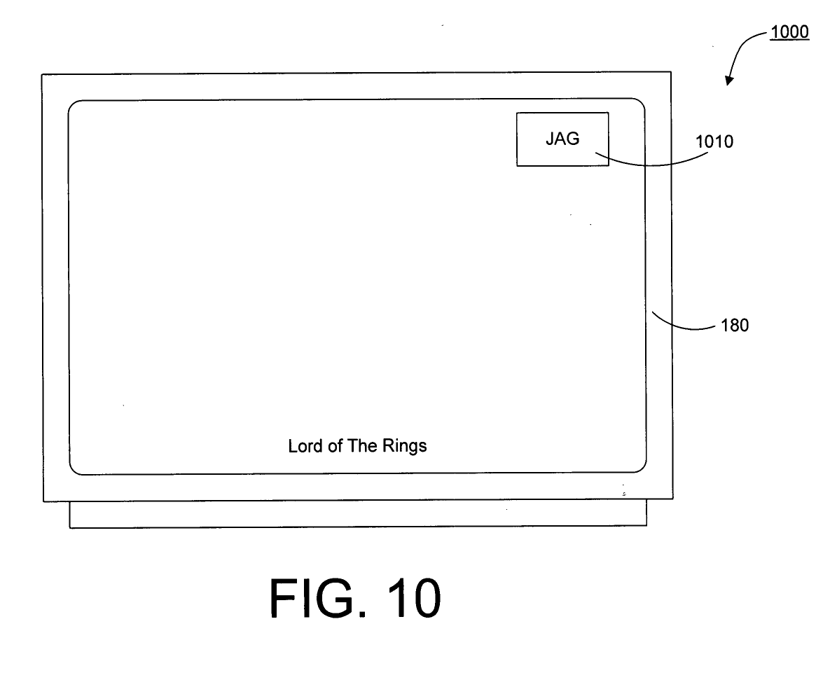

The primary device 140 may view the current presentation of a remote device, such as remote device 150-1, through picture-in-picture (PIP). While viewing the network guide 500, a present presentation can be highlighted and/or selected and a second tuner in the primary device 140 can be used to create a picture-in-picture view 1010 on the display device 180 of the presentation currently playing on the remote device 150-1 as shown in FIG. 10. Instead of the second tuner, the data stream being sent to, for example, remote device 150-1 could be duplicated inside of the primary device 140 and displayed using the secondary MPEG decoder. If the presentation 540 of JAG was highlighted on the network guide 500 and the PIP option buttons on a remote control were utilized, JAG would appear on the display device 180 attached to the primary device 140 in the PIP view 1010. In another embodiment, if the presentation 540 of JAG were highlighted on the network guide 500 and the select button on a remote control was used, JAG would appear on the display device 180 attached to the primary device 140 in the PIP view 1010. In an another embodiment, while viewing a PIP from the remote device 150-1, the “+” and “−” buttons on the remote control can be used to check the programs being currently viewed on all of the remote devices by tuning to each current program on each remote device 150-1 to 150-n when selected.

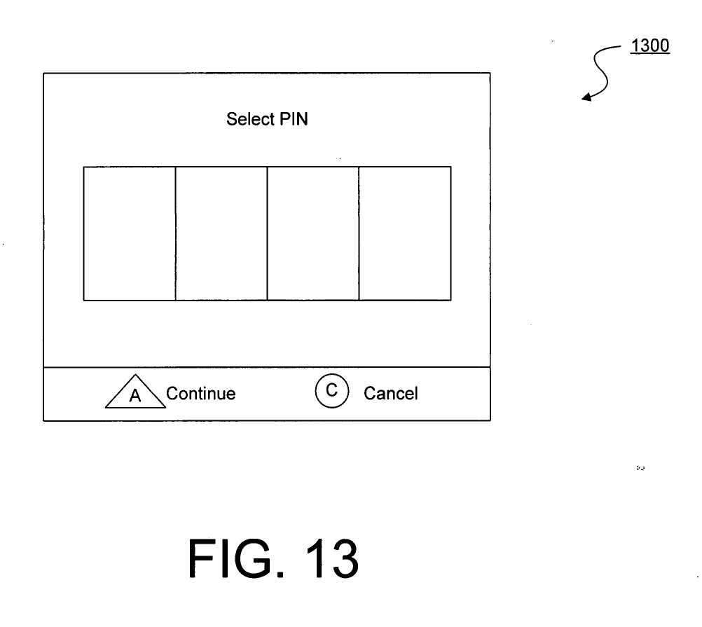

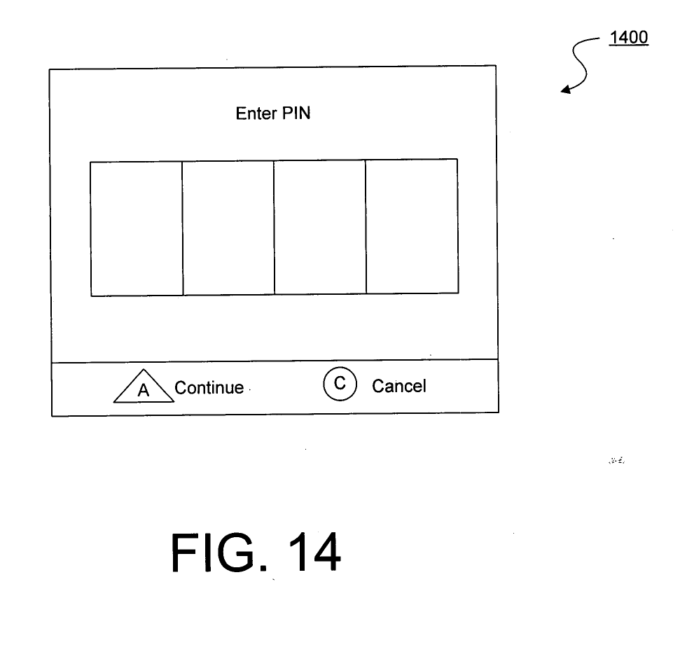

Referring back to FIG. 5, the network guide 500 has two icons “B” and “C”. The “B” icon 570 is labeled Block and is used as a further means of parental control. From the primary device 140, the user may block any currently tuned or recorded signal on any of the remote devices 150-1 to 150-n. To implement the block, the user can highlight the desired presentation in the network guide 500 and then press a button on the remote control, such as “B”, which corresponds to the “B” icon 570 on the network guide 500. The updated network guide 500 is then saved on the primary device 140 and distributed to the remote devices 150-1 to 150-n. A prompt may appear asking the user if the block should be applied to the same program appearing at a future date and time or if it should be applied to the entire channel. If no tuners are available to tune to the QAM channel, the remote devices 150-1 to 150-n are notified via the HE 120 that authorization has been revoked. A prompt could also appear asking the user if the block should be applied to the same program on additional remote devices 150-1 to 150-n. A prompt may also appear to create a PIN such as in FIG. 13. The user enters a password, such as a four digit number, to ensure the program remains blocked. For example, if a user on the remote device 150-1 attempts to view the blocked program, a prompt for the PIN entered at the primary device 140 will appear, such as in FIG. 14. Only after the correct PIN has been entered will the remote device 150-1 be able to view the program. As soon as the blocked program ends, the block will expire.

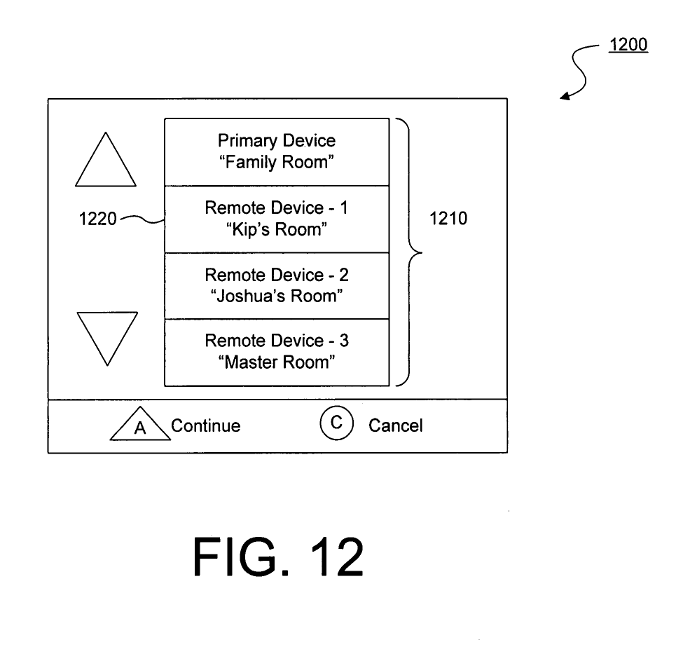

The “C” icon 530 is labeled Customize as shown in FIG. 5 and corresponds to a “C” button on a remote control. One embodiment of a customize screen 1100, as shown in FIG. 11, includes the options to Rename the Networked Devices, Display Status Changes, or View PIP. The user may select the option Rename the Network Devices 1110. After selecting the rename option 1110, a screen 1200 displaying all of the networked remote devices may be displayed as shown in FIG. 12. The screen 1200 then lists the primary device 140 along with the remote devices 150-1 to 150-n that are in the networked system of FIG. 1. For example, the Family Room and the remote devices 150-1 and 150-2 are shown as being networked in the remote devices list 1210. A user can select a highlighted listing 1220, which in this case is remote device 150-1, to rename that remote device with a more identifiable name.

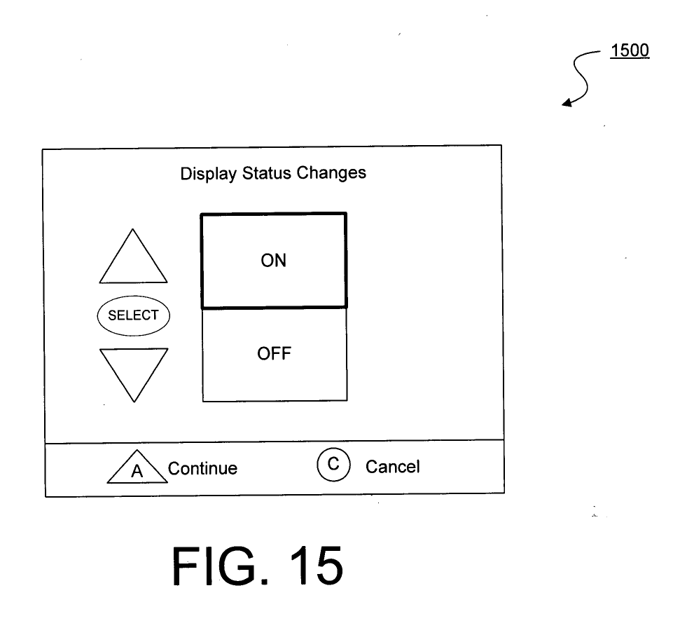

The user can also choose whether or not to display status changes of any of the remote devices 150-1 to 150-n. Once in the customization screen 1100 of FIG. 11, the user selects Display Status Changes 1120, and the screen 1200 displaying the networked remote devices may again be displayed as shown in FIG. 12. The Family Room and the remote devices 150-1 and 150-2 are shown as being networked in the remote devices list 1210. A user can select the highlighted listing 1220, which in this case is remote device 150-1, resulting in the display of Display Status Changes screen 1500 appearing as shown in FIG. 15. The Display Status Changes screen 1500 includes the options on and off. In one implementation, a user may choose either option by using the up and down arrow keys on the remote control to highlight the desired entrant. After the user has chosen the desired option, the user may activate the option, for example, by using the “A” key on the remote control.

When the option of displaying status changes is on, the primary device 140 is constantly monitoring the remote devices 150-1 to 150-n and will create a changed status display 810 as shown in FIG. 8 on the display device 180 when a change in status is detected by the primary device 140. The change in status can include, for example, the remote device 150-1 to 150-n being turned on, off, changing a channel, changing volume, or watching a program saved on the primary device 140. The changed status display 810 can be anywhere on the display device screen 180 including the top, bottom, or sides and can be displayed using text or icons.

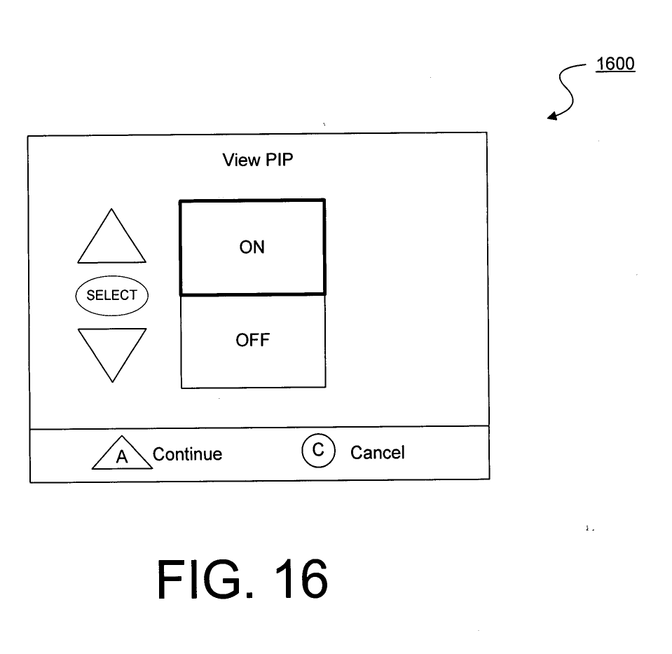

The user can also select the View PIP option 1130 as shown in FIG. 11. The user again chooses one of the remote devices, such as 150-1, as shown in FIG. 12. Once the particular remote device has been chosen, the user selects whether or not to monitor the presentation as shown in FIG. 16. If the user turns on the option, the PIP screen 1010 will appear on the display device 180 attached to the primary device 140 to allow a user to verify suitability of a program for the remote device 150-1.

It should be emphasized that the above-described embodiments of the invention are merely possible examples, among others, of the implementations, setting forth a clear understanding of the principles of the invention. Many variations and modifications may be made to the above-described embodiments of the invention without departing substantially from the principles of the invention. All such modifications and variations are intended to be included herein within the scope of the disclosure and invention and protected by the following claims. In addition, the scope of the invention includes embodying the functionality of the embodiments of the invention in logic embodied in hardware and/or software-configured mediums.

1. A method for utilizing parental control in a networked multi-room system (NMS), said method comprising the steps of:
providing a network guide on a primary device of said NMS;
providing an indication of status of one or more remote devices of said NMS on said network guide; and
controlling said remote device form said primary device in response to said indication of status of said one or more remote devices.

2. The method of claim 1, wherein said control step comprises from said primary device blocking a tuned or recorded signal from displaying from one of said remote devices.

3. The method of claim 2, further comprising the step of prompting a user to block said tuned or recorded signal from displaying on another remote device.

4. The method of claim 1, wherein said control step comprises blocking a tuned signal received in said remote device from said primary device.

5. The method of claim 4, further comprising the step of a block on a presentation expiring at the conclusion of said presentation.

6. The method of claim 1, wherein said control step comprises from said primary device blocking a signal tuned by said remote device.

7. The method of claim 6, further comprising the step of a block on a presentation expiring at the conclusion of said presentation.

8. The method of claim 1, wherein said control step comprises from said primary device blocking a presentation recorded by said remote device from being displayed by said remote device.

9. The method of claim 8, further comprising the step of a block on a presentation expiring at the conclusion of said presentation.

10. The method of claim 1, wherein said control step comprises from said primary device blocking a presentation recorded by said primary device from being displayed on said remote device.

11. The method of claim 10, further comprising the step of a block on a presentation expiring at the conclusion of said presentation.

12. The method of claim 1, wherein said indication of status is a channel change.

13. The method of claim 12, wherein said control step comprises blocking a presentation in response to a user of the primary device receiving said channel change.

14. The method of claim 13, further comprising the steps of:
updating said network guide on said primary device with said blocked presentation; and
the primary device distributing the updated network guide to said remote devices.

15. The method of claim 1, further comprising the step of displaying a password screen in order to block said presentation.

16. The method of claim 15, further comprising the step of unblocking a blocked presentation on said remote device after entering a password on said password screen.
